(19) United States
(12) Patent Application Publication
(10) Pub. No.: US 2013/0088863 A1
(43) Pub. Date: Apr. 11, 2013

(54) LIGHTING DEVICE

(71) Applicant: SAMSUNG ELECTRONICS CO., LTD., Suwon-si (KR)

(72) Inventors: Jong Kil PARK, Suwon-si (KR); Bang Weon LEE, Suwon-si (KR); Tae Gyu KIM, Hwasung-si (KR)

(73) Assignee: SAMSUNG ELECTRONICS CO., LTD., Suwon-si (KR)

(21) Appl. No.: 13/647,905

(22) Filed: Oct. 9, 2012

(30) Foreign Application Priority Data
Oct. 7, 2011 (KR) 10-2011-0102516

(51) Int. Cl. F21V 21/00; F21V 29/00; F21V 15/00

(52) U.S. Cl. 362/218; 362/217.1; 362/362; 362/373

(57) ABSTRACT

A lighting device may include a circuit substrate comprising a first surface and a light emitting device, and a cover to which the circuit substrate is installed, so as to receive the light emitting device. The cover includes at least one opening, and at least one portion of a second surface is exposed to an external side though the at least one opening.

### CROSS-REFERENCE TO RELATED APPLICATION

This application claims the benefit of Korean Patent Application No. 10-2011-0102516, filed on Oct. 7, 2011, in the Korean Intellectual Property Office, the disclosure of which is incorporated herein by reference.

### BACKGROUND

1. Field

Embodiments relate to a lighting device. More particularly, embodiments relate to a tube-type light emitting diode (LED) lighting device that does not additionally utilize a heat sinking plane, since a portion of a circuit substrate, to which an LED package is installed, is exposed to an external side.

2. Description of the Related Art

A light emitting diode (LED) refers to a semiconductor device that emits a light when a current flows and transforms electric energy to light energy, and refers to an electric component that is a PN junction diode including a gallium arsenide (GaAs) and a gallium nitride (GaN) optical semiconductor.

Recently, blue LEDs and ultraviolet light LEDs embodied using a nitride having superior physical and chemical characteristics have been developed. A scope of applications for the LED has been expanded since a white light or another monochromatic light may be generated using a blue LED or an ultraviolet LED and a fluorescent substance.

The LED may have features of a long lifespan, a small size, and a light weight, and may operate with a low voltage since the LED has a strong directivity. Also, the LED is robust against impact and vibration, does not require a warm-up time, and is readily operated. Thus, the LED may be utilized for diverse uses. For example, the scope of applications for the LED has been expanded to include a small lighting of a mobile terminal, an indoor illumination, an outdoor illumination, a courtesy light of a car, and backlight of a large liquid crystal display (LCD), etc.

Heat sinking measures may be required for products containing the LED among varied subjects utilizing the LED. Deterioration in a lifespan of the LED, due to heat, is a great drawback. In particular, a tube-type LED has a lower calorific value than a general lighting device. Thus, studies on a lighting device without a heat sinking plane have been conducted.

The LED lighting device, using a metal circuit substrate, has a low assembling efficiency due to its complexity. Further, the LED lightning device has low productivity at a high cost, since many components are used. The LED lightning device also has a reduced lifespan, since heat generated form the LED is not efficiently radiated. In particular, when the LED generates a high heat, the heat has to be radiated quickly since non-radiated heat reduces the lifespan of the LED. When heat sinking is not effectively performed, the lifespan of the LED may be reduced.

The tube-type LED lighting device may increase a heat sinking characteristic when using a heat sinking plane, but may fail to reduce its weight. Further, a structure of the tube-type LED, in which a circuit substrate is inserted into a cylinder-shaped cover, may reduce the weight but may decrease the heat sinking characteristic.

### SUMMARY

An aspect of the embodiments may provide a lighting device including a circuit substrate to which a light emitting diode (LED) package is installed, and a portion of a surface of the circuit substrate is exposed to an external side so as to function as a heat sinking plane. Thus, the lighting device may not use a separate heat sinking plane.

Another aspect of the embodiments may also provide a lighting device that reduces a weight and maintains a superior heat sinking characteristic.

Still another aspect of the embodiments may also provide a lighting device that strongly fixes a circuit substrate to a cover, and prevents curvature due to a weight of the device itself and a thermal deformation.

According to an aspect of the embodiments, there is provided a lighting device, including a circuit substrate including a first surface and a light emitting device, and a cover to which the circuit substrate is installed, so as to receive the light emitting device, and the cover includes at least one opening, and at least one portion of a second surface of the circuit substrate is exposed to an external side through the at least one opening.

The cover may be provided in a shape of a cylinder, the at least one opening may be formed along a longitudinal direction of the cover, and the circuit substrate may be disposed on the at least one opening, to enable an internal space receiving the light emitting device to be formed by the circuit substrate and an internal surface of the cover.

The at least one opening is a plurality of openings may be formed along a longitudinal direction of the cover, so that the second surface of the circuit substrate is partially exposed to the external side.

The cover may include a fixing groove portion formed at the opening of the cover to fix the circuit substrate, the fixing groove portion may be a slot formed at both sides of the at least one opening along a longitudinal direction of the cover, the first surface of the circuit substrate may be formed towards an internal side of the cover, and the second surface of the circuit substrate may be formed towards an external side of the cover.

A height of the fixing groove portion may be less than a height of the circuit substrate, and the fixing groove portion may support the circuit substrate and may maintain a contact state with the circuit substrate.

An upper portion protrusion, which forms the fixing groove portion and is in contact with the second surface of the circuit substrate, may be formed on the cover in a zigzag shape.

A contact area between the cover and the circuit substrate, may be applied with a thermally conductive sealant, so that heat generated from the circuit substrate is transferred to the cover through the thermally conductive sealant.

A cap may be combined with both end portions of the cover, and a connection pin electrically connected with the circuit substrate may be protruding from the cap in an external direction.

According to another aspect of the embodiments, there is provided a lighting device, including a circuit substrate including a first surface and a light emitting device, a cover including an opening through which a second surface of the circuit substrate is exposed and receiving the light emitting device, and caps at both ends of the cover fix the circuit substrate, the caps include a connection pin electrically connected with the circuit substrate.

The caps include cap grooves to which both ends of the circuit substrate are inserted and fixed, and the cap grooves may be formed of a material having a thermal conductivity that is lower than a thermal conductivity of the cover.

The circuit substrate may be disposed to close the opening of the cover, and the cover may be not in contact with the second surface of the circuit substrate.

A contact area between the cover and the circuit substrate may be applied with a thermally conductive sealant, so that heat generated from the circuit substrate may be transferred to the cover through the thermally conductive sealant.

According to still another aspect of the embodiments, there is provided a lighting device, including a circuit substrate including a first surface and a light emitting device, a cover comprises an opening through which a second surface of the circuit substrate is exposed to an external side, and the cover receiving the light emitting device, and a protrusion portion formed on the second surface of the circuit substrate, the protrusion portion and the circuit substrate are formed of a same material.

The protrusion portion may be integrally formed with the circuit substrate.

The protrusion portion may include at least one of a corrugated structure formed along the second surface of the circuit substrate, a pin structure formed along the second surface of the circuit substrate, an uneven structure formed along the second surface of the circuit substrate, and a groove structure formed along the second surface of the circuit substrate.

A height of the protrusion portion may become higher at a center of the second surface of the circuit substrate than a horizontal side edge of the second surface of the circuit substrate.

According to still another further aspect of the embodiments, there is provided a lightning device including a board including a first substrate and a light emitting device, a cylindrical body including an opening through which a second surface of the board is exposed and receiving the light emitting device; and caps at both ends of the cylindrical body fix the board, the caps include a connection pin to electrically connect the cap with the circuit substrate, wherein a sealant is applied between the board and the cylindrical body so that heat generated from the board is transferred through the cylindrical body.

The sealant may have a thermally conductive material.

Additional aspects, features, and/or advantages of the embodiments will be set forth in part in the description which follows and, in part, will be apparent from the description, or may be learned by practice of the embodiments.

### BRIEF DESCRIPTION OF THE DRAWINGS

These and/or other aspects, features, and advantages of the embodiments will become apparent and more readily appreciated from the following description of embodiments, taken in conjunction with the accompanying drawings of which:

FIG. 1 is a perspective view of a lighting device according to an embodiment;

FIG. 2 is a partially exploded perspective view of the lighting device of FIG. 1;

FIG. 3 is a diagram illustrating a circuit substrate of FIG. 2;

FIG. 4 is an exploded sectional view of the lighting device of FIG. 1;

FIG. 5 is a magnified sectional view of the portion B of FIG. 2;

FIG. 6 is a planar view of an example modified from the lighting device of FIG. 1;

FIG. 7 is a partial perspective view of another example modified from the lighting device of FIG. 1;

FIG. 8 is an exploded perspective view of a lighting device according to another embodiment;

FIG. 9 is a sectional view of the lighting device of FIG. 8;

FIG. 10 is a sectional view of a lighting device according to still another embodiment;

FIG. 11 is a sectional view of an example modified from the lighting device of FIG. 10; and

FIGS. 12A through 12D are diagrams illustrating a temperature distribution of a lighting device according to an embodiment.

### DETAILED DESCRIPTION

Reference will now be made in detail to embodiments, examples of which are illustrated in the accompanying drawings, wherein like reference numerals refer to the like elements throughout. Embodiments are described below to explain the embodiments by referring to the figures.

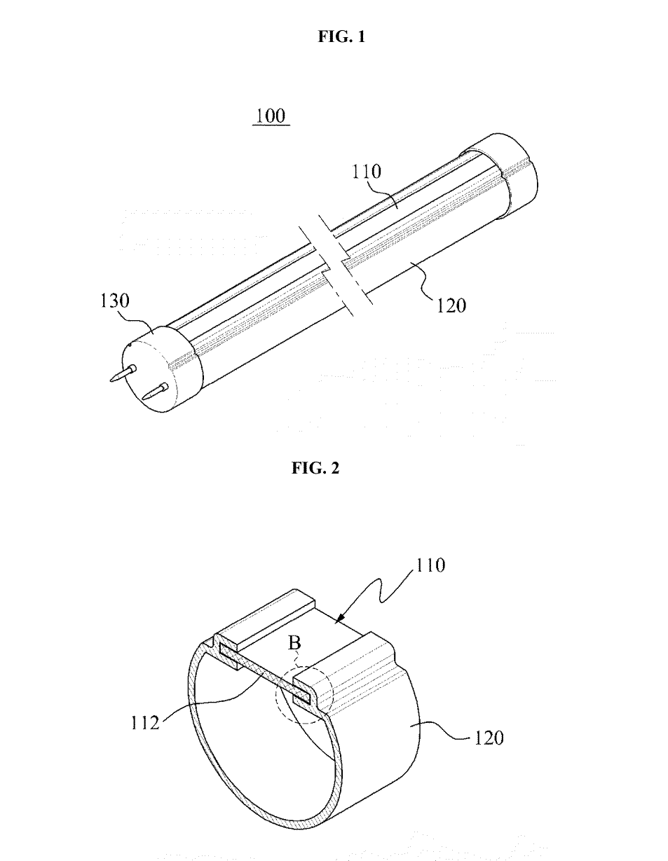

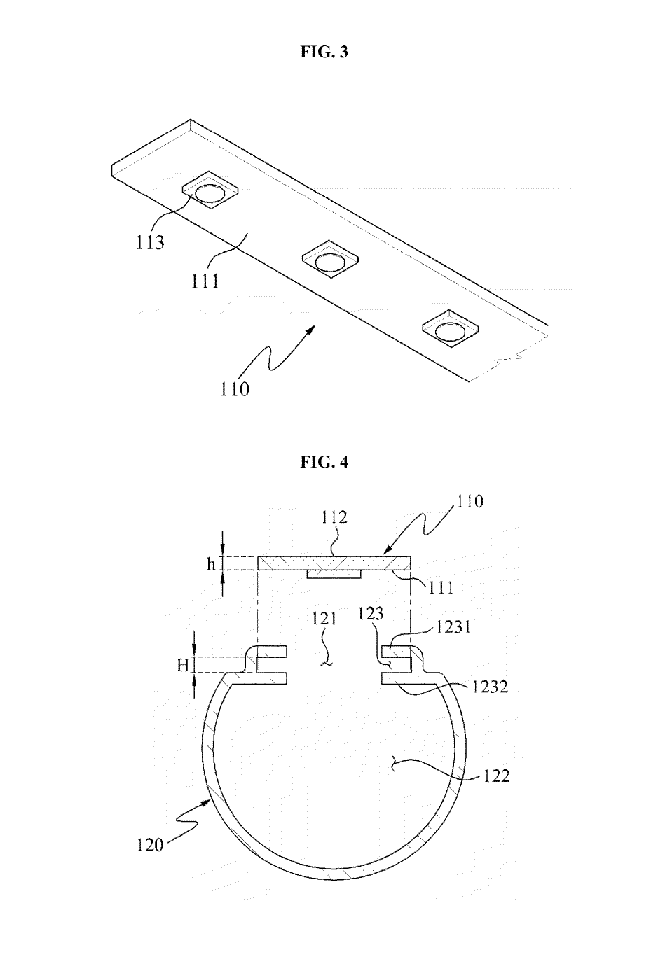

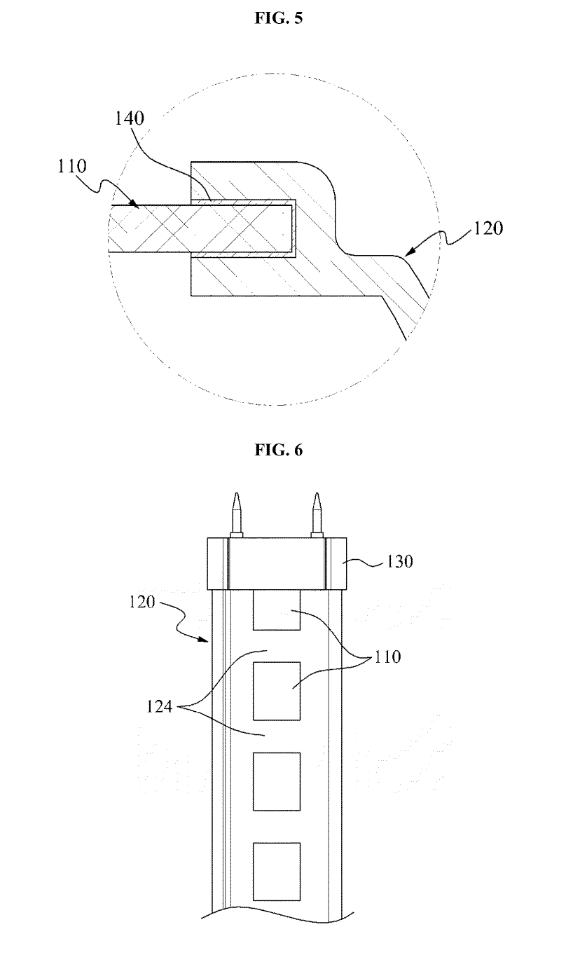

FIG. 1 illustrates a lighting device 100 according to an embodiment, FIG. 2 illustrates a partially exploded perspective view of the lighting device 100, FIG. 3 illustrates a circuit substrate 110, and FIG. 4 illustrates an exploded sectional view of the lighting device 100. Also, FIG. 5 illustrates a magnified sectional view of the portion B of FIG. 2.

Referring to FIG. 1, the lighting device 100 may include the circuit substrate 110, a cover 120, and a cap 130.

A light emitting diode (LED) package may be mounted on the circuit substrate 110. When the LED package, electrically connected with a connection pin of the cap 130, emits a light, lighting is performed through the cover 120.

The circuit substrate 110 may have a structure, that is inserted into the cover 120, provided in a shape of a cylinder. A light emitting device 113, e.g., the LED package, may be mounted on the circuit substrate 110. The circuit substrate 110 may be a metal matrix circuit substrate, e.g., a metal core printed circuit board (MCPCB) or an FR4 printed circuit board (PCB)

Referring to FIG. 3, the light emitting device 113, e.g., an LED, may be mounted on a first surface 111 of the circuit substrate 110. A plurality of the light emitting devices 113 may be mounted in a pattern on the circuit substrate 110.

The cover 120 may fix the circuit substrate 110, so as to receive the light emitting device 113 at an internal side, and may include at least one opening 121. The cover 120 may be formed of synthetic resins, glass material, etc. Thus, the cover 120 may effectively emit a light generated from the light emitting device 113.

Referring to FIGS. 2 and 4, the cover 120 is formed in a shape of a cylinder, and the opening 121 is formed on an upper portion, along a longitudinal direction of the cylinder. The circuit substrate 110 may be disposed and fixed on a side of the opening 121 of the cover 120. Although the exemplary embodiment describes that the cover 120 is provided in a shape of the cylinder, the shape of the cover 120 is not limited thereto. For example, the cover 120 may be formed in varied shapes, e.g., a polygonal section shape including a triangular shape or a quadrangular shape, an elliptical section shape, a circular shape, etc.

The first surface 111 of the circuit substrate 110 may be formed towards an internal space 122 of the cover 120, so that the lighting emitting device 113 may perform lighting through the internal space 122 and the cover 120. At least one portion of the second surface 112 of the circuit substrate 110 may be exposed to an external side through the opening 121. The at least one portion of the second surface 112 is exposed to the external side. Thus, heat generated from the light emitting device 113 may pass through the second surface 112 of the circuit substrate 110 and may be effectively radiated to an external side.

A fixing groove portion 123 may be formed at a side of the opening 121 of the cover 120 to fix the circuit substrate 110. The fixing groove portion 123 may be a slot formed at both sides of the opening 121 along a longitudinal direction of the cover 120, and may be formed by an upper portion protrusion 1231 and a lower portion protrusion 1232. The circuit substrate 110 may be inserted into the fixing groove portion 123 for fixing, so that the first surface 111 may be formed in a direction towards the internal space 122 of the cover 120, and the second surface 112 may be formed in a direction towards an external side.

A height (H) of the fixing groove portion 123 may be desirably formed to be shorter than a height (h) of the circuit substrate 110. Accordingly, when the circuit substrate 110 is inserted into the fixing groove portion 123, the circuit substrate 110 and the cover 120 may be strongly combined with each other due to a slightly narrow space of the fixing groove portion 123. The strong combination between the circuit substrate 110 and the cover 120 may maintain an adequate state of contact between the circuit substrate 110 and the cover 120, so that heat generated from the light emitting device 113 may be effectively transferred to the cover 120 through the circuit substrate 110. Accordingly, since an area exposed to an external side may increase, heat transferred through an external surface of the cover 120 may be effectively radiated.

The combination between the circuit substrate 110 and the cover 120 may be primarily conducted through the fixing groove portion 123, and may be secondarily fixed through a cap 130 combined with both sides of the cover 120.

Referring to FIG. 5, a thermally conductive sealant 140 may be applied between the cover 120 and the circuit substrate 110. In other words, a space between the cover 120 and the circuit substrate 110 may be applied with the thermally conductive sealant 140, so that heat generated from the circuit substrate 110 may be effectively transferred to the cover 120 through the sealant 140 and may be radiated to an external side of the cover 120.

Examples of the sealant 140 may include a thermally conductive grease or paste. Since a thermally conductive material may be used as a sealant, examples of the sealant are not limited to the aforementioned examples.

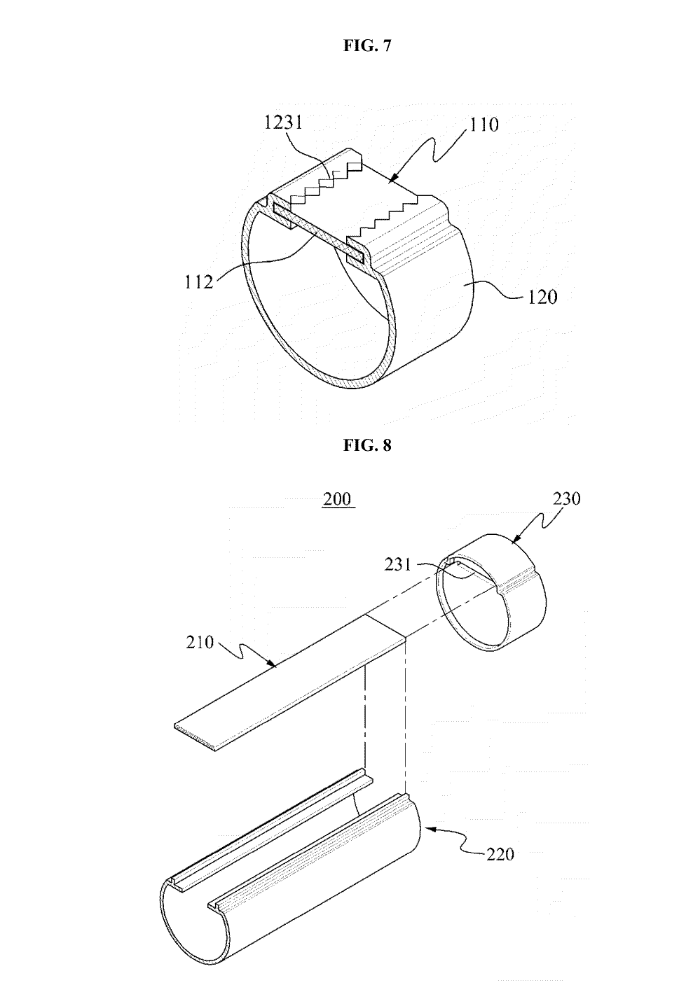

FIG. 6 illustrates a lighting device modified from the lighting device 100 of FIG. 1. The modified lighting device may include a plurality of openings 121 formed on an upper portion of the cover 120, along a longitudinal direction of the cover 120.

A cover upper portion connecting member 124 may be formed on the upper portion of the cover 120, and may connect both sides of separated upper portions of the cover 120. The plurality of openings 121 may be formed by the cover upper portion connecting member 124. The second surface 112 of the circuit substrate 110 may be partially exposed to an external side through the plurality of openings 121, and heat may be effectively radiated through the openings 121.

The cover 120 may effectively deal with a curvature, due to a weight of the device, and a thermal deformation, using the cover upper portion connecting member 124 formed on the upper portion of the cover 120

Gravity may be applied to the cover 120. Thus, a curvature may occur due to a weight of the device, and the plurality of openings 121 formed on the upper portion may also have a modest effect on the curvature. However, the cover upper portion connecting member 124 may firmly fix portions of the cover 120 at both sides of the opening 121. Thus, the curvature, due to a weight of the device, and the thermal deformation, may be effectively prevented.

When heat is generated from the circuit substrate 110, the thermal deformation may occur. Although the thermal deformation occurs, the cover 120 may stably maintain an intrinsic shape using the cover upper portion connecting member 124.

FIG. 7 illustrates another lighting device modified from the lighting device 100 of FIG. 1. The upper portion protrusion 1231 of the fixing groove portion 123 may be formed in a zigzag shape or a saw-toothed shape.

The upper portion protrusion 1231, formed on an upper portion of the cover 120, may be in contact with the second surface 122, and may be formed in a zigzag shape or a saw-toothed shape. Thus, an area of the second surface 122 of the circuit substrate 110, exposed to an external side, may increase. Accordingly, a heat sinking performance of the circuit substrate 100 may be improved.

When compared to a case in which the upper portion protrusion 1231 is provided in a linear shape, the upper portion protrusion 1231, formed in a zigzag shape or a saw-toothed shape, may provide a space that is deformed from a center to an external side of the second surface 122. Accordingly, an area of the second surface 112 of the circuit substrate 110, exposed to an external side, may be increased by as much as the space which is directly connected with an increase in a heat sinking effect.

Hereinafter, a lighting device 200, according to another exemplary embodiment, will be described, and portions substantially the same as portions of the lighting device 100 will be omitted for conciseness.

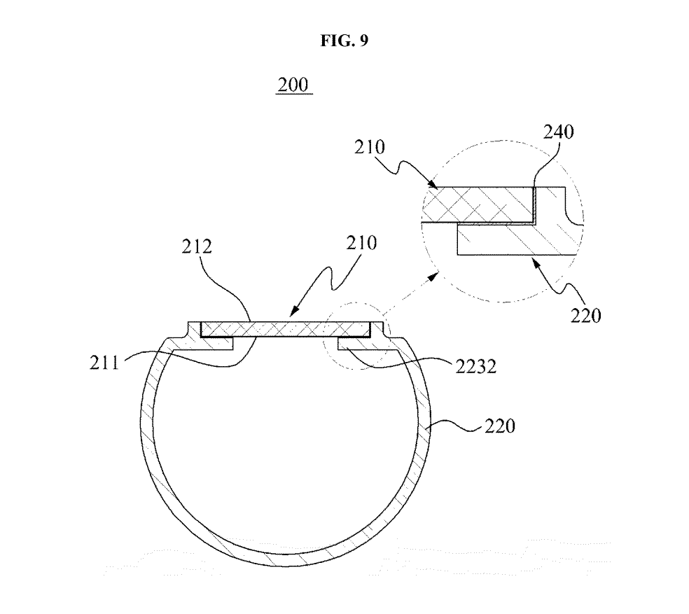

FIG. 8 illustrates an exploded perspective view of the lighting device 200, and FIG. 9 illustrates a sectional view of the lighting device 200.

Referring to FIGS. 8 and 9, the lighting device 200 may include a circuit substrate 210, equipped with a first surface 211 to which a light emitting device is to be installed, a cover 220, including an opening through which a second surface 212 of the circuit substrate 210 is exposed to an external side and receiving the light emitting device, a cap 230, included in both ends of the cover 220 to fix the circuit substrate 210, and the cap equipped with a connection pin to electrically connect the cap with the circuit substrate 210.

The circuit substrate 210 may be substantially the same as the circuit substrate 110. Thus, descriptions thereof will be omitted for conciseness.

As illustrated in FIG. 9, the cover 220 may be formed in a shape of a cylinder. An opening is formed to be longest along a longitudinal direction of the cylinder. The circuit substrate 210 may be disposed on the opening and may be fixed by the cap 230.

A lower portion protrusion 2232, which is formed at a side of the opening, may be formed on an upper portion of the cover 220. The lower portion protrusion 2232 may be formed along a longitudinal direction of the cover 220 to be protruding at both sides of the opening, so as to face each other. The circuit substrate 210 may be safely disposed on the lower portion protrusion 2232.

A separate upper portion protrusion, which is formed on an upper portion of the lower portion protrusion 2232, may not be formed on the upper portion of the cover 220. In other words, the circuit substrate 210 is merely safely disposed on the upper portion of the cover 220 by the lower portion protrusion 2232, and may not directly form a structural combination with the cover 220. A structure, including the cover 220, is not additionally formed on the second surface 212 of the circuit substrate 210. Thus, an area of the second surface 212 exposed to an external side may be maximized. Further, heat generated from the circuit substrate 210, may be readily radiated to an external side.

The combination between the circuit substrate 210 and the cover 220 may be conducted by the cap 230. The cap 230 may be equipped with a cap groove 231. The cap groove 231 may be a slot to which an end of the circuit substrate 210 is inserted for fixing. Also, the cap 230 is combined with each end portion of a longitudinal side of the cover 220. Thus, the circuit substrate 210 and the cover 220 are firmly combined with each other.

A height of the cap groove 231 may be desirably formed to be slightly smaller than a height of the circuit substrate 210. Accordingly, when the circuit substrate 210 is inserted to the cap groove 231, the circuit substrate 210 and the cap 230 are strongly combined with each other due to a modestly narrow space of the cap groove 231. The modestly narrow space of the cap groove 231 directly affects the strong combination between the circuit substrate 210 and the cover 220.

The cap groove 231 may be desirably formed of a material having a lower thermal conductivity than the cover 220. An amount of heat transferred to the cover 220 may be increased to be greater than an amount of heat transferred to a portion around the cap groove 231, so that radiating heat from the cover 220 may be promoted. Also, the cap groove 231 may be desirably formed of a material, having a lower thermal deformation, than the circuit substrate 210. In other words, when the cap groove 231 may be formed of a material, having a lower thermal deformation, than the circuit substrate 210, deterioration in coherence due to the thermal deformation may be prevented.

A contact area between the circuit substrate 210 and the cover 220 may be applied with a thermally conductive sealant 240. As described in the foregoing exemplary embodiment, a space between the circuit substrate 210 and the cover 220 may be applied with the thermally conductive sealant 240. Therefore, heat generated from the circuit substrate 210 may be effectively transferred to the cover 220 through the sealant 140.

Also, when a material having an adhesive strength and a thermally conductive material is used as the sealant 240, the circuit substrate 210 and the cover 220 may be more firmly combined with each other.

Hereinafter, a lighting device 300, according to still another exemplary embodiment, will be described. Portions substantially the same as portions of the lighting device 100 and the lighting device 200 will be omitted for conciseness.

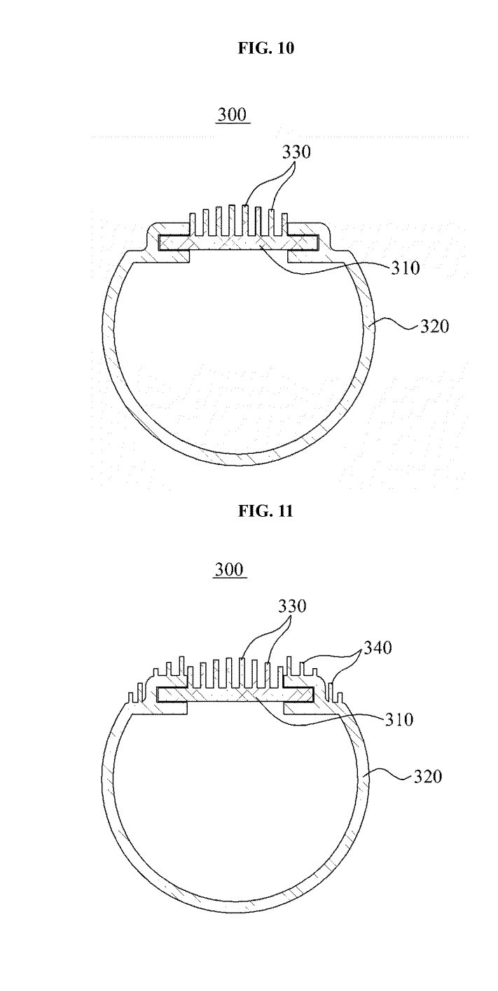

FIG. 10 illustrates a sectional view of the lighting device 300.

Referring to FIG. 10, the lighting device 300 may include a circuit substrate 310, equipped with a first surface to which a light emitting device is installed, a cover 320, including an opening through which a second surface of the circuit substrate 310 is exposed to an external side and receiving a light emitting device, and a protrusion portion 330, formed on the second surface of the circuit substrate 310 and formed of the same material as the circuit substrate 310.

The first surface of the circuit substrate 310 may be a surface formed in a direction towards an internal side of the cover 320. The light emitting device is mounted on the surface. The second surface of the circuit substrate 310 may be a surface at an opposite side of the first surface, and may be exposed to an external side through an opening of the cover 320.

The protrusion portion 330 formed of the same material as the circuit substrate 310 may be formed on the second surface of the circuit substrate 310. The protrusion portion 330 may be formed to be integrated with the circuit substrate 310, or may be formed separately from the circuit substrate 310 and combined together.

The protrusion portion 330 may include a corrugated structure formed along the second surface of the circuit substrate 310, a pin structure formed along the second surface of the circuit substrate 310, an uneven structure formed along the second surface of the circuit substrate 310, or a groove structure formed along the second surface of the circuit substrate 310.

An area of the circuit substrate 310 exposed to an external side through the opening of the cover 320 may be significantly increased by the protrusion portion 330. In other words, the protrusion portion 330 may be formed of the same material as the circuit substrate 310. Thus, the protrusion portion 330 and the circuit substrate 310 may have the same thermal conductivity. Accordingly, heat from the circuit substrate 310 may be readily transferred to the protrusion portion 330. A heat sinking effect of the circuit substrate 310 may be dramatically improved, based on the increased exposed area by the protrusion portion 330.

A height of the protrusion portion 330 may become higher from a horizontal side edge to a center of the second surface of the circuit substrate 310. The shape of the protrusion portion 330 may not be limited to that within a space in which the cover 320, which is substantially in a shape of a cylinder, is installed. The shape of the protrusion portion 330 may significantly increase the area exposed to an external side.

According to the exemplary embodiment, the cover 320 and the cap may be formed in the same manner as the covers 110 and 210 and the caps 130 and 230. Accordingly, descriptions thereof will be omitted for conciseness.

FIG. 11 illustrates a lighting device modified from the lighting device 300 of FIG. 10. The modified lighting device may include a first protrusion portion 330, formed on the second surface of the circuit substrate 310, and a second protrusion portion 340, formed on an upper portion of the cover 320.

The first protrusion portion 330 may have a structure substantially the same as the protrusion portion 330 of FIG. 10. Hereinafter, descriptions as to the first protrusion portion 330 will be omitted for conciseness.

A plurality of the second protrusion portions 340 may be formed along both sides of the opening of the cover 320 in a longitudinal direction. The second protrusion portion 340 may be formed of the same material as the cover 320, or may be formed of a material having a superior thermal conductivity than the cover 320. The second protrusion portion 340 may be formed to be integrated with the cover 320, or may be formed separately from the cover 320 and then combined.

The second protrusion portion 340 may include at least one of a corrugated structure formed along an upper portion of the cover 320, a pin structure formed along the upper portion of the cover 320, an uneven structure formed along the upper portion of the cover 320, and a groove structure formed along the upper portion of the cover 320.

The first protrusion portion 330 and the second protrusion portion 340 may be protruding to enable an external shape of the cover 320 to be formed in a shape of a cylinder based on a space in which the cover 320, which is substantially in a shape of a cylinder, is installed.

An area of the second surface of the circuit substrate 310, exposed to an external side, may be significantly increased by the first protrusion portion 330. An area of the upper portion of the cover 321 to an external side may be significantly increased by the second protrusion portion 340. Accordingly, a heat sinking effect of the circuit substrate 310 and the cover 320 may be dramatically improved by the first protrusion portion 330 and the second protrusion portion 340.

Although a structure in which a protrusion portion is not formed on the second surface of the circuit substrate 310 and a protrusion portion is formed on the upper portion of the cover 320 may be provided as another modified example, detailed descriptions thereof will be omitted.

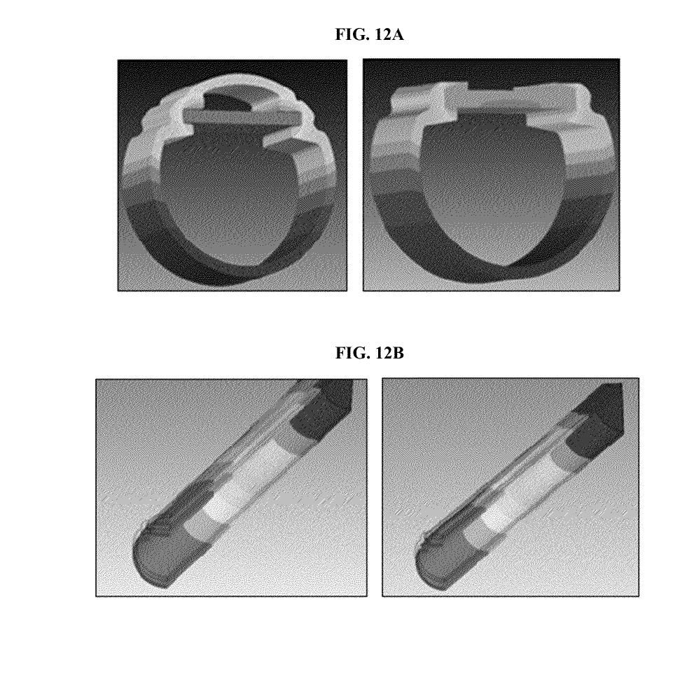

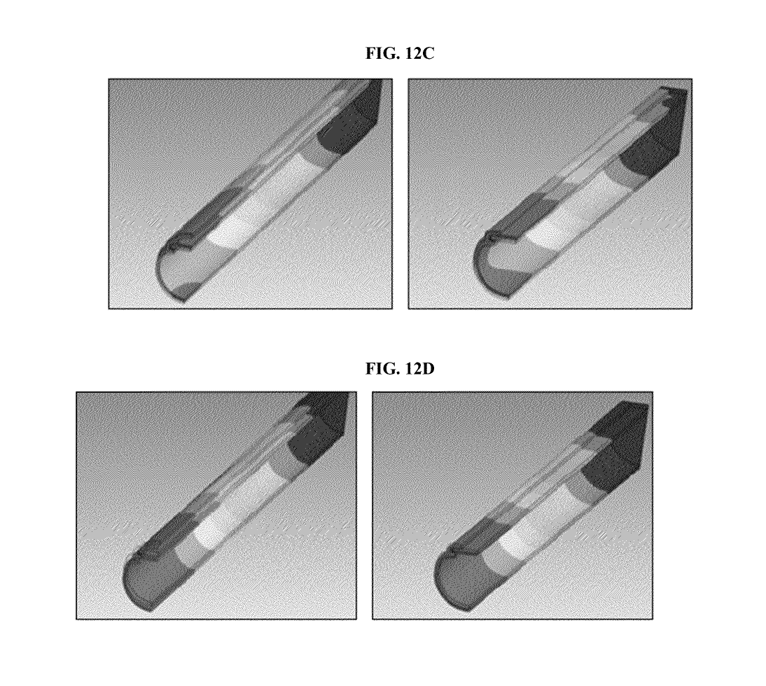

FIGS. 12A through 12D illustrate an experimental result of a thermal and structural characteristics of a related art lighting device and the lighting device 100 under the same conditions.

Referring to FIG. 12A, a comparison of thermal characteristics may be provided. A temperature provided by the related art lighting device is 74.5° C. (as shown on the left side of FIG. 12A), and a temperature provided by the lighting device 100 is 69.9° C. (as shown on the right side of FIG. 12A). Accordingly, the lighting device 100 may have an improved heat sinking effect, by as much as 4.6° C., when compared to the related art lighting device.

FIG. 12B shows a comparison of a degree of a curvature due to a weight of the device, FIG. 12C shows a comparison of a thermal deformation occurring in a direction opposite to gravity, and FIG. 12D shows a comparison of a thermal deformation occurring in the direction of gravity.

Referring to FIG. 12B, a curvature due to a weight of the device of the related art lighting device is (+) 0.55 millimeters (mm) (as shown on the left side of FIG. 12B). A curvature due to a weight of the lighting device 100 is (+) 0.75 mm (as shown on the right side of FIG. 12B). FIG. 12C shows analytical data indicating a thermal deformation caused by heat, without taking an effect of gravity into consideration. A thermal deformation of the related art lighting device is (−) 0.13 mm (as shown on the left side of FIG. 12C), and a thermal deformation of the lighting device 100 is (−) 0.15 mm (as shown on the right side of FIG. 12C). FIG. 12D shows data indicating an actual thermal deformation that may occur, during operation, based on gravity. A thermal deformation of the related art lighting device on the left side of FIG. 12D is (+) 0.44 mm, which is the same as a thermal deformation of the lighting device 100 (on the right side of FIG. 12D).

Accordingly, when the lighting devices are not operated, the curvature of the lighting device 100 due to a weight of the device is worse than the related art device. However, when the lighting devices are operated, the lighting devices may have substantially the same thermal deformation. In other words, there is little difference in the thermal deformation between the lighting devices when the lighting devices are operated.

A result of the comparison result is shown in Table 1.

TABLE 1
A comparison based on thermal and structural characteristics

| | | curvature due to a | |
|---|---|---|---|
| | | weight of the | Thermal |
| | Tmax(° C.) | device itself (mm) | deformation (mm) |
| Conventional | 74.5 | 0.55 | 0.44 |
| lighting device | | | |
| Proposed | 69.9 | 0.75 | 0.44 |
| lighting device | | | |

As shown in Table 1, the lighting device according to exemplary embodiments may have a superior heat sinking characteristic and has no significant structural differences from the related art lighting device.

Although a few embodiments have been shown and described, embodiments are not limited to the described embodiments. Instead, it would be appreciated by those skilled in the art that changes may be made to these described embodiments without departing from the principles and spirit of the embodiments, the scope of which is defined by the claims and their equivalents.

What is claimed is:

1. A lighting device, comprising:
a circuit substrate comprising a first surface and a light emitting device; and
a cover to which the circuit substrate is installed so as to receive the light emitting device,
wherein the cover includes at least one opening, and at least one portion of a second surface of the circuit substrate is exposed to an external side through the at least one opening.

2. The lighting device of claim 1, wherein the cover is provided in a shape of a cylinder, the at least one opening is formed along a longitudinal direction of the cover, and the circuit substrate is disposed on the at least one opening, to enable an internal space receiving the light emitting device to be formed by the circuit substrate and an internal surface of the cover.

3. The lighting device of claim 1, wherein the at least one opening is a plurality of openings, formed along a longitudinal direction of the cover, so that the second surface of the circuit substrate is partially exposed to the external side.

4. The lighting device of claim 1, wherein the cover includes a fixing groove portion formed at the opening of the cover to fix the circuit substrate, the fixing groove portion is a slot formed at both sides of the at least one opening, along a longitudinal direction of the cover, the first surface of the circuit substrate is formed towards an internal side of the cover, and the second surface of the circuit substrate is formed towards an external side of the cover.

5. The lighting device of claim 4, wherein a height of the fixing groove portion is less than a height of the circuit substrate, and the fixing groove portion supports the circuit substrate and maintains a contact state with the circuit substrate.

6. The lighting device of claim 4, wherein an upper portion protrusion, which forms the fixing groove portion and is in contact with the second surface of the circuit substrate, is formed on the cover in a zigzag shape.

7. The lighting device of claim 1, wherein a contact area between the cover and the circuit substrate is applied with a thermally conductive sealant, so that heat generated from the circuit substrate is transferred to the cover through the thermally conductive sealant.

8. A lighting device, comprising:
a circuit substrate comprising a first surface and a light emitting device;
a cover comprising an opening through which a second surface of the circuit substrate is exposed and receiving the light emitting device; and
caps disposed at both ends of the cover to fix the circuit substrate, the caps comprising connection pins electrically connected with the circuit substrate.

9. The lighting device of claim 8, wherein the caps comprise cap grooves to which both ends of the circuit substrate are inserted and fixed, and the cap grooves are formed of a material having a thermal conductivity that is lower than a thermal conductivity of the cover.

10. The lighting device of claim 8, wherein the circuit substrate is disposed to close the opening of the cover, and the cover is not in contact with the second surface of the circuit substrate.

11. The lighting device of claim 8, wherein a contact area, between the cover and the circuit substrate, is applied with a thermally conductive sealant, so that heat generated from the circuit substrate is transferred to the cover through the thermally conductive sealant.

12. A lighting device, comprising:
a circuit substrate comprising a first surface and a light emitting device;
a cover comprising an opening through which a second surface of the circuit substrate is exposed to an external side, and the cover receiving the light emitting device; and
a protrusion portion formed on the second surface of the circuit substrate, the protrusion portion and the circuit substrate are formed of a same material.

13. The lighting device of claim 12, wherein the protrusion portion is integrally formed with the circuit substrate.

14. The lighting device of claim 12, wherein the protrusion portion comprises at least one of a corrugated structure formed along the second surface of the circuit substrate, a pin structure formed along the second surface of the circuit substrate, an uneven structure formed along the second surface of the circuit substrate, and a groove structure formed along the second surface of the circuit substrate.

15. The lighting device of claim 12, wherein a height of the protrusion portion becomes higher at a center of the second surface of the circuit substrate than a horizontal side edge of the second surface of the circuit substrate.

16. A lightning device, comprising:
a board comprising a first surface and a light emitting device;
a cylindrical body comprising an opening through which a second surface of the board is exposed and receiving the light emitting device; and
caps at both ends of the cylindrical body which fix the board, the caps comprising connection pins to electrically connect the caps to the board,
wherein a sealant is applied between the board and the cylindrical body so that heat generated from the board is transferred to the cylindrical body.

17. The lightning device of claim 16, wherein the sealant has a thermally conductive material.

18. The lightning device of claim 16, wherein the caps comprise cap grooves to which both ends of the board are inserted and fixed, and the cap grooves are formed of a material having a thermal conductivity that is lower than a thermal conductivity of the cylindrical body.

19. The lightning device of claim 16, wherein the board is disposed to close the opening of the cylindrical body, and the cylindrical body is not in contact with the second surface of the board.
